(19) United States
(12) Patent Application Publication
(10) Pub. No.: US 2017/0143160 A1
(43) Pub. Date: May 25, 2017

(54) OUTDOOR HEAT SOURCE ABOVE COOKING/GRILLING SURFACE APPARATUS AND METHOD

(71) Applicant: Michaeal Singer, Harrisville, MI (US)

(72) Inventor: Michaeal Singer, Harrisville, MI (US)

(21) Appl. No.: 15/361,030

(22) Filed: Nov. 24, 2016

Related U.S. Application Data
(60) Provisional application No. 62/259,171, filed on Nov. 24, 2015.

(51) Int. Cl. A47J 37/07; A47J 36/08

(52) U.S. Cl. CPC A47J 37/07; A47J 36/08

(57) ABSTRACT

An outdoor cooking/grilling apparatus comprising at least one cooking/grilling surface, a removable pan disposed below the cooking/grilling surface(s), and a heat source disposed above the cooking/grilling surface(s), all of which elements are contained within an enclosure. The heat surface being disposed above the cooking/grilling surface(s) avoids flare-ups that would otherwise result when secretions from a cooked foodstuff would come into contact with the heat source. Instead, such secretions are collected in the pan and may be used to enhance the palatability of the foodstuff prior to consumption. A heat shield may be provided for retaining and redirecting heat from the heat source in the enclosure, a safety mechanism may selectively activate and deactivate the heat source, and the heat source may be adjustably positionable with respect to the cooking/grilling surface(s). A method for cooking/grilling is also disclosed.

### CROSS-REFERENCE TO RELATED APPLICATIONS

The present disclosure claims priority under 35 United States Code, Section 119 on U.S. Provisional Patent Application 62/259,171, filed on Nov. 24, 2015, the disclosure of which is incorporated by reference.

### FIELD

The present disclosure relates to an outdoor cooking/grilling apparatus, and particularly, to an apparatus with the heat source element disposed above the cooking/grilling surface and a method for cooking with such an apparatus.

### BACKGROUND

Outdoor cooking/grilling is a desirable method of food preparation as an open flame heat source, generally from ignited natural or propane gas, may be utilized to provide for unique and desirable characteristics of palatability as the food is prepared. Present outdoor cooking/grilling methods utilize a heat source that is disposed below the grilling surface. The grilling surface is the surface on which food is placed for cooking. This orientation of the heat source with respect to the grilling surface results in food secretions dripping into the heat source, which consequently results in fire, flame and flare-ups. These flare-ups adversely affect the palatability of the food being cooked on the grill as well as the loss of secretions from the food (which diminishes flavor of the food and inefficient use of energy in the cooking process.)

Accordingly, there exists a need for a cooking apparatus that reduces, if not eliminating, the instance of food secretions coming into contact with the heat source during the grilling process and such associated flare-ups that negatively affect the quality of the cooked food.

### SUMMARY

In view of the foregoing disadvantages of the prior art, the present disclosure for an apparatus for outdoor cooking wherein the heat source is disposed above at least one cooking surface. This configuration maximizes the potential of the palatability of foodstuffs cooked by the apparatus by placing the heat source above the cooking/grilling surface to prevent adverse cooking/grilling conditions to include but limited to unintended burning due to fire and flare-ups that results from food secretions dripping directly upon the heat source during cooking/grilling. The configuration of the apparatus also allows for preservation of the food secretions as they collect below the foodstuffs and heat source (so that the secretions may be saved and utilized in the cooking process to enhance the foodstuffs, for example) as well as for reflecting the heat source energy into the foodstuffs improving the cooking/grilling process while conserving energy or reducing energy usage in the process.

In an embodiment, the apparatus comprises a “clam-shell” enclosure, wherein an upper portion and lower portion of the “clam-shell” are hingedly connected for opening and closing access to the cooking/grilling surface. In an embodiment, the heat source of a cooking apparatus is disposed above the at least one cooking/grilling surface. In a further exemplary embodiment, a radiant shield may be integrated into the upper portion of the “clam-shell” enclosure to improve energy efficiency and cooking/grilling characteristics.

Further, the heat source may be adjustable in the vertical plane, i.e., with respect to the cooking/grilling surface(s), to vary the impact of the heat source on the foodstuffs. A fail-safe safety mechanism may be provided and incorporated into the upper clam-shell portion of the enclosure to reduce or extinguish the heat source when the upper clam-shell is opened and to reignite or return power to the heat source when the upper clam-shell enclosure is again closed. In another embodiment, below the cooking/grilling surface(s), sufficiently distanced from the heat source to prevent or reduce the potential of ignition, a removable pan/container may be provided for collecting food secretions that are generated and fall from foodstuffs during the cooking process, so, if desired, such secretions may be incorporated into the foodstuffs.

These together with other aspects of the present disclosure, along with the various features of novelty that characterize the present disclosure, is pointed out with particularity in the claims annexed hereto and forms a part of this present disclosure. For a better understanding of the present disclosure, its operating advantages, and the specific objects attained by its uses, reference should be made to the accompanying drawing and descriptive matter in which there are illustrated exemplary embodiments of the present disclosure.

### DETAILED DESCRIPTION OF THE DRAWINGS

The advantages and features of the present invention will become better understood with reference to the following detailed description and claims taken in conjunction with the accompanying drawings, wherein like elements are identified with like symbols, and in which:

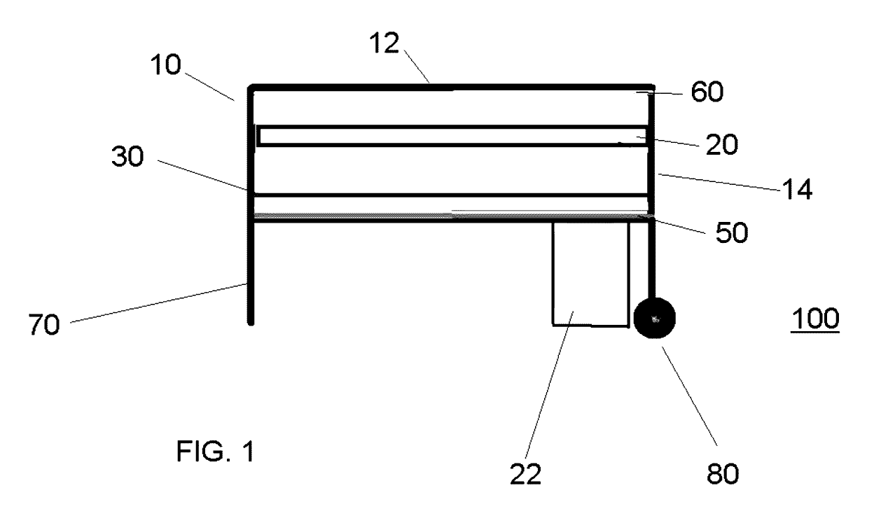

FIG. 1 shows a cutaway view of outdoor cooking/grilling apparatus, in accordance with an exemplary embodiment of the present disclosure; and

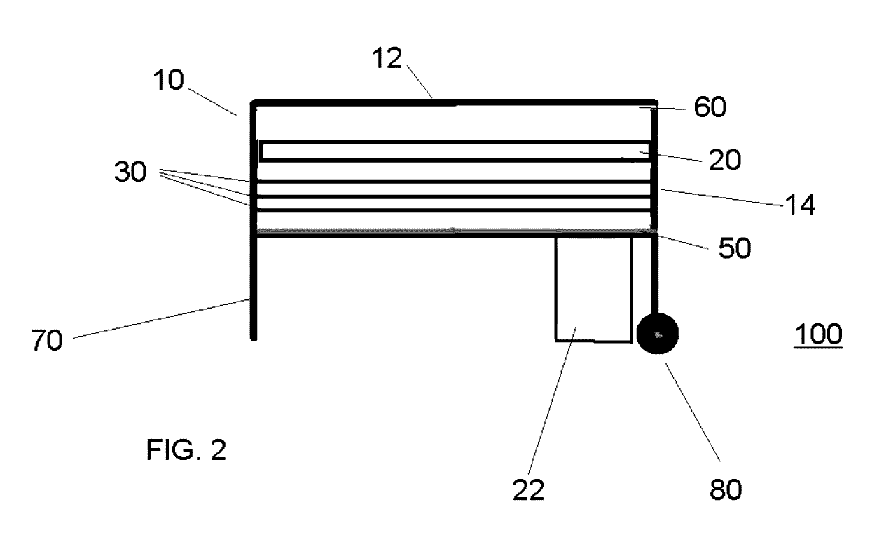

FIG. 2 shows an outdoor cooking/grilling apparatus with a plurality of cooking surfaces, in accordance with an exemplary embodiment of the present disclosure.

### DETAILED DESCRIPTION OF THE DISCLOSURE

The best mode for carrying out the present disclosure is presented in terms of its preferred embodiment, herein depicted in the accompanying figures. The preferred embodiments described herein detail for illustrative purposes are subject to many variations. It is understood that various omissions and substitutions of equivalents are contemplated as circumstances may suggest or render expedient, but are intended to cover the application or implementation without departing from the spirit or scope of the present disclosure.

The terms “a” and “an” herein do not denote a limitation of quantity, but rather denote the presence of at least one of the referenced items.

The present disclosure provides for an outdoor cooking/grilling apparatus wherein the heat source is disposed above the cooking surface or surfaces, as well as a method for cooking with such an apparatus. The at least one cooking surface of the apparatus may be a grill configuration or other configuration that is capable of receiving a foodstuff and receiving heat from the heat source. Preferably, the at least one cooking surface will comprise apertures or other openings that allow heat to flow through the cooking surface and for secretions from the foodstuffs on the cooking surface to drip or fall through the cooking surface to an area underneath the cooking surface.

With the heat source being disposed above the cooking surface(s) and foodstuff that is being cooked, secretions from that may fall the foodstuff during the cooking process do not come into contact with the heat source, thus avoiding flare-ups around the cooking surface(s) and avoiding burning or destruction of the secretions. A removable pan/container (hereinafter, “pan”) may be provided below the cooking surface(s) for collecting those food secretions that are generated and fall from foodstuffs during the cooking process. The pan so disposed to collection secretions, if desired, such secretions may be incorporated into the foodstuffs. Furthermore, a radiant heat shield may be disposed above the heat source for retaining energy and otherwise improving the efficiency of the apparatus.

Referring now to FIG. 1, a cutaway view of components of an outdoor cooking/grilling apparatus 100 is shown, in accordance with an exemplary embodiment of the present disclosure. The apparatus 100 comprises an enclosure 10 and heat source 20 and a cooking/grilling surface 30 disposed within the enclosure 10. The heat source 20 is disposed above the at least one cooking/grilling surface 30. This configuration maximizes the potential of the palatability of foodstuffs cooked by the apparatus 100 by placing the heat source 20 above the at least one cooking/grilling surface 30 to prevent adverse cooking/grilling conditions that occur in the prior art, such as unintended burning of the foodstuffs due to fire and flare-ups that results from food secretions dripping directly upon the heat source during cooking/grilling. The configuration of the apparatus 100 also allows for preservation of the food secretions as they collect below the foodstuffs and heat source 20 (so that the secretions may be saved and utilized in the cooking process to enhance the foodstuffs, for example) as well as for reflecting the heat source energy into the foodstuffs improving the cooking/grilling process while conserving energy or reducing energy usage in the process.

In an embodiment, the apparatus 100 comprises a “clam-shell” enclosure 10, wherein an upper portion 12 and lower portion 14 of the clam-shell are hingedly connected for opening and closing access to the at least one cooking/grilling surface 30. When the clam-shell of the enclosure 10 is in an open position, a user may access the cooking/grilling surface 30 to place or manipulate foodstuffs thereon. The clam-shell may be placed in a closed position to retain heat within the enclosure 10 for the cooking process. A handle (not shown) on the enclosure 10 may be provided for facilitating opening and closing of the enclosure 10.

The apparatus further comprises a heat source 20 for cooking foodstuffs. The heat source 20 includes a fuel supply 22, such as electricity, propane gas or charcoal for example. The heat source will also include a heating element (such as a coil that receives the electricity, burners that receives gas, or a fire box that receives charcoal) for releasing the heat into the enclosure 10. The fuel supply is operatively coupled to the heat source 20. The heat source 20 of a cooking apparatus is disposed above the at least one cooking/grilling surface 30. It will be apparent that the heat source being disposed above the cooking surface obviates the possibility of secretions (such as juices) from foodstuffs coming into contact with the heat source 20 during the cooking process—thus ensuring that instances of flare-ups from such secretions that otherwise occur in prior art cooking devices is eliminated.

In an embodiment, the heat source 20 may be adjustable, and in a further embodiment, adjustable in the vertical plane, i.e., with respect to distance to the at least one cooking/grilling surface 30, to vary the impact and/or effect of the heat source 20 on the foodstuffs. Such adjustability may be accomplished by a lever, a pulley arrangement, or any other actuation mechanism known in the art. The adjustability may be such that opening of the enclosure 10 is not required to adjust the position of the heat source 20. For example, the lever may extend out of the enclosure 10 while the enclosure 10 is closed so that the user may manipulate the lever to adjust the position of the heat source 20 without opening the enclosure 10.

In another embodiment, a safety mechanism 40 is provided for selectively activating or deactivating power or the fuel supply to the heat source 20. The safety mechanism 40 may comprise a switch for controlling power or fuel supply to the heat source. In an embodiment, opening the enclosure 10 will temporarily trip the switch such that power or the fuel supply to the heat source 20 is disconnected. In such an embodiment, closing the enclosure 10 reconnects the power or fuel supply 22 to the heat source 20.

In another embodiment, a pan 50 may be disposed below the cooking/grilling surface, which pan 50 may collect secretions that are generated and fall from foodstuffs during the cooking process. It will be apparent that the pan 50 is sufficiently distanced from the heat source 20 to prevent or reduce the potential of ignition of the secretions that are collected in the pan. The pan may be removable from the enclosure so that a user may, for example, remove the pan after a desired amount of secretions have been collected on the pan and use those secretions in a recipe or subsequently in the cooking process to enhance the flavor of the cooked foodstuff.

A radiant heat shield 60 may be provided in the upper portion of the enclosure 10 (i.e., above the heat source). The heat shield 60 is preferably disposed between the heat source 20 and the upper portion 10 of the enclosure so that heat that emanates upwardly from the heat source 20 is contained or redirected within the enclosure 10 by the heat shield 60, thereby increasing the efficiency of energy usage in the cooking process.

The apparatus 100 may further comprise a frame 70, which frame 70 may support the enclosure 10 away from the ground. The frame 70 may also enclose the power or fuel supply for the heat source 20. At least one wheel 80 may be incorporated with the frame 70 to provide for portability of the apparatus 100.

In another embodiment, and referring to FIG. 2, the apparatus 100 comprises a plurality of cooking/grilling surfaces 30, each of which cooking/grilling surface is disposed below the heat source 10 and above a pan 50. The plurality of cooking/grilling surfaces are preferably disposed above and below one another so that different cooking/grilling surfaces can be different distances from the heat source and therefore be subjected to different temperatures for the cooking process.

In another embodiment, the at least one cooking/grilling surface 30 may be disposed on a drawer that allows the at least one cooking/grilling surface 30 to be slidably inserted and removed from the enclosure 10.

In another embodiment, a method for cooking/grilling with a heat source disposed above at least one cooking surface is provided. In an embodiment, the method comprises providing an apparatus such as the apparatus 100 described above and with at least one cooking/grilling surface and a heat source, with said heat source being disposed above the at least one cooking/grilling surface. The apparatus of the method may further comprise a removable pan that is disposed below the at least one cooking/grilling surface. The method further comprises placing a foodstuff on the at least one cooking/grilling surface and having heat emanate from the heat source to the at least one cooking/grilling surface and foodstuff. The method further comprises cooking the foodstuff to a preferred degree of doneness and collecting foodstuff secretions generated during the cooking process in the removable pan. The method concludes with consuming the cooked foodstuff, and optionally, using the collected secretions to season the foodstuff prior to consumption.

The apparatus and method disclosed herein provide for efficient cooking of foodstuffs by placing the heat source above the cooking/grilling surface(s) to prevent unintended fire and flare-ups (that are undesirable and/or damaging to the foodstuff being cooked) that would otherwise result from food secretions dripping directly upon the heat source. The apparatus and method dispose the heat source out of the way of such foodstuff secretions during the cooking process and allow for collection and preservation of secretions during cooking/grilling (so that the secretions may be saved and utilized to enhance the foodstuffs) as well as reflecting the heat source energy into the foodstuffs, thereby making the cooking/grilling process more efficient as well as conserving energy.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

The following list of proposed claims are not meant to be restrictive or all-inclusive but are only provided to illustrate by way of example some of the new features of the disclosure described herein.

What is claimed is:

1. An outdoor cooking/grilling apparatus, the apparatus comprising
a heat source,
at least one cooking/grilling surface,
a removable pan, and
an enclosure,
wherein said enclosure is openable and closable,
wherein said heat source, at least one cooking/grilling surface are contained within said enclosure,
wherein said heat source is disposed above said at least one cooking/grilling surface within said enclosure,
wherein said removable pain is disposed below said at least one cooking/grilling surface within said enclosure,
such that when a foodstuff is placed in said at least one cooking/grilling surface and is heated by said heat source, the foodstuff is cooked and any secretions from the foodstuff do not come into contact with the heat source.

2. The apparatus of claim 1, wherein said enclosure comprises a clam-shell configuration with an upper half and a lower half, and wherein said upper-half of said enclosure is hingedly connected to said lower half, said upper-half and said-lower half capable of opening and closing for providing selective access to the interior of the enclosure.

3. The apparatus of claim 1, said apparatus further comprising a radiant heat shield disposed above said heat source.

4. The apparatus of claim 1, wherein the position of said heat source within said enclosure is adjustable.

5. The apparatus of claim 1, wherein the apparatus further comprises a safety mechanism for selectively activating and deactivating the heat source.

6. The apparatus of claim 1, wherein the apparatus further comprises a frame for supporting the enclosure and at least one wheel for allowing movement of the apparatus.

7. The apparatus of claim 1, wherein the apparatus further comprises at least one drawer, wherein said at least one drawer receives said at least one cooking surface for slidably inserting and removing said at least one cooking surface in and from the enclosure.

8. A method for method for cooking/grilling with a heat source disposed above the cooking surface, the method comprising:
providing a cooking/grilling apparatus, said apparatus comprising at least one cooking/grilling surface, a removable pan and a heat source, said heat source being disposed above the at least one cooking/grilling surface and said pan being disposed below said at least one cooking/grilling surface,
placing a foodstuff on the at least one cooking/grilling surface and having heat emanate from the heat source to the at least one cooking/grilling surface and foodstuff,
cooking the foodstuff to a preferred degree of doneness and collecting foodstuff secretions generated by the foodstuff during the cooking process in the removable pan, and
consuming the cooked foodstuff.

9. The method of claim 8, wherein the method further comprises using the collected secretions to season the foodstuff prior to consumption.
